(19) United States
(12) Patent Application Publication
(10) Pub. No.: US 2016/0271541 A1
(43) Pub. Date: Sep. 22, 2016

(54) OIL / WATER SEPARATION MEDIA AND METHOD OF USING SAME

(71) Applicant: Southeast Nonwovens, Inc., Clover, SC (US)

(72) Inventor: Steven F. Nielsen, Charlotte, NC (US)

(21) Appl. No.: 14/950,767

(22) Filed: Nov. 24, 2015

Related U.S. Application Data
(60) Provisional application No. 62/205,815, filed on Aug. 17, 2015.
(60) Provisional application No. 62/205,831, filed on Aug. 17, 2015.
(60) Provisional application No. 62/134,077, filed on Mar. 17, 2015.

(51) Int. Cl. B01D 39/04; B01D 15/10

(52) U.S. Cl. CPC B01D 39/04; B01D 15/10

(57) ABSTRACT

A filter medium for removing oil from an aqueous material can include a three dimensional solid made from a plurality of fibers, in which at least some of the fibers are oleophilic or oleophilic and hydrophilic. The solid can be a variety of shapes, such as a sphere, cylinder, cone, cube, cuboid, parallelepiped, polyhedron, prism, spheroid, ellipsoid, paraboloid, hyperboloid, ring and/or combinations thereof.

### CROSS REFERENCE TO RELATED APPLICATIONS

This application claims priority to U.S. Provisional Patent Application No. 62/205,815, filed Aug. 17, 2015, U.S. Provisional Patent Application No. 62/205,831, filed Aug. 17, 2015, and U.S. Provisional Patent Application No. 62/134,077, filed Mar. 17, 2015. All of said applications are incorporated by reference herein.

### TECHNICAL FIELD OF INVENTION

The present invention relates to a filter media. One embodiment of the invention comprises a filter medium for separating oil and water. Another embodiment of the invention comprises a filter device using the filter medium.

### BACKGROUND OF INVENTION

Oil/aqueous materials, such as oil/water and oil/water based mixtures, are common and often undesirable. Frequently, it is desirable to remove oil from aqueous material. Accordingly, there is a need for filter media that can remove oil from oil/aqueous materials in a simple, economical, and environmentally-friendly manner.

### SUMMARY OF INVENTION

An object of the present invention is to provide filter media that can efficiently remove oil from aqueous materials. This and other objects of the invention can be achieved by embodiments of the invention disclosed below.

One embodiment of the invention comprises filter media for removing oil from an aqueous material. The filter media comprises a three dimensional solid comprised of a plurality of fibers, in which at least some of the fibers are oleophilic. The solid can be a variety of shapes, such as a sphere, cylinder, cone, cube, cuboid, parallelepiped, polyhedron, prism, spheroid, ellipsoid, paraboloid, hyperboloid, and/or ring.

According to another embodiment of the invention, some of the fibers are oleophilic and hydrophilic.

According to another embodiment of the invention, the plurality of fibers can be polyolefins, polyesters, polyamides, cellulosics, and/or combinations thereof.

According to another embodiment of the invention, the plurality of fibers are at least two different polymers.

According to another embodiment of the invention, the plurality of fibers comprise a first fiber having a first denier, and a second fiber having a second denier different from the first denier.

According to another embodiment of the invention, the oleophilic fibers have an adhesive surface and an oil-absorbing particle affixed to the adhesive surface.

According to another embodiment of the invention, at least some of the fibers are oleophilic or oleophilic and hydrophilic, and have an adhesive surface and an oil-absorbing particle affixed to the adhesive surface.

According to another embodiment of the invention, the adhesive surface comprises a thermally active surface.

According to another embodiment of the invention, the adhesive surface comprises a tacky surface.

According to another embodiment of the invention, a plasticizer is applied to the tacky surface.

According to another embodiment of the invention, the tacky surface is tackified by a chemical agent.

According to another embodiment of the invention, a filter apparatus comprises a cartridge having an inlet and an outlet, and contains a filter media adapted for removing oil from an aqueous material. The filter media comprises a three dimensional solid comprised of a plurality of fibers, in which at least some of the fibers are oleophilic fibers.

According to another embodiment of the invention, at least some of the fibers are oleophilic or oleophilic and hydrophilic.

According to another embodiment of the invention, the plurality of fibers are comprised of polyolefin, polyester, polyamide, cellulosic, or combinations thereof.

According to another embodiment of the invention, the plurality of fibers are comprised at least two different polymers. For example, the plurality of fibers can include polyolefin and polyester fibers.

According to another embodiment of the invention, the plurality of fibers include fibers having different deniers.

According to another embodiment of the invention, each of the oleophilic or olephilic/hydrophyllic fibers can have an adhesive surface and an oil-absorbing particle affixed to the adhesive surface. The adhesive surface can be thermally active surface or tacky.

### BRIEF DESCRIPTION OF THE DRAWINGS

FIG. 1 is a perspective view of oil/water separation media according to a preferred embodiment of the invention;

FIG. 2 is a perspective view of a filter apparatus according to a preferred embodiment of the invention; and

FIG. 3 is another perspective view of the filter apparatus of FIG. 2.

### DETAILED DESCRIPTION OF PREFERRED EMBODIMENTS OF INVENTION AND BEST MODE

According to a preferred embodiment of the invention, filter media for separating oil from an aqueous material comprises a three-dimensional solid comprised of a plurality of fibers. At least some of the fibers are oleophilic or oleophilic and hydrophobic. Oleophilic, as used herein, refers to a substance having an affinity for oils and not for water. Hydrophobic refers to a substance having little or no affinity for water.

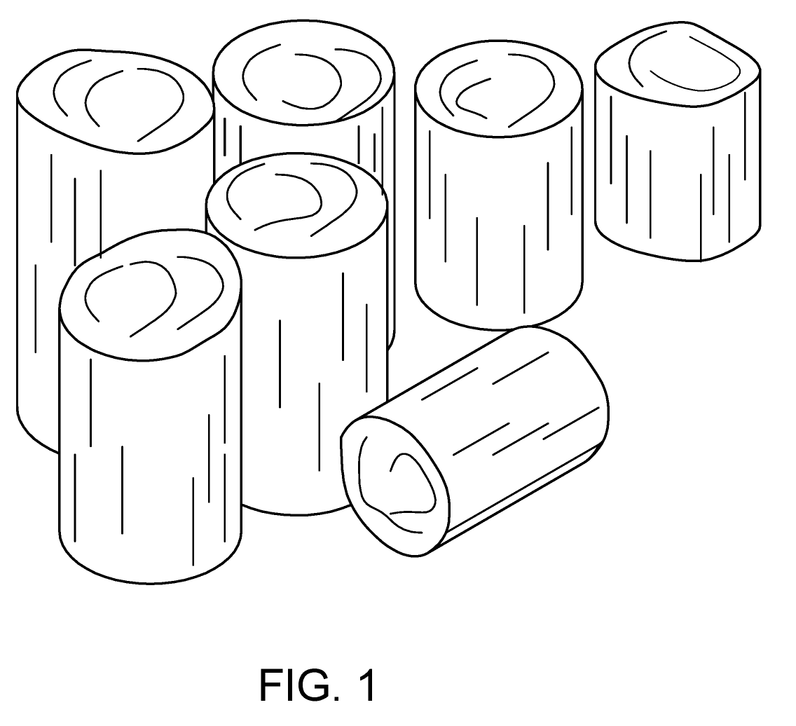

The filter media, according to a preferred embodiment of the invention, comprises a solid having a three dimensional shape, such as cylindrical, as shown at reference numeral 10 in FIG. 1. A three-dimensional solid, as used herein, refers to any three-dimensional solid. Preferably, the three-dimensional solids have a length/diameter (L/D) ratio in the range of 0.1-5:1. In a preferred embodiment, the L/D ratio is in the range of 1-3:1. In another preferred embodiment, the L/D ratio is in the range of 1-2:1. The three-dimensional solids can be a variety of shapes. The three-dimensional solids can be, but are not limited to, spheres, cylinders, cones, cubes, cuboids, parallelepipeds, polyhedrons (e.g., pyramid, tetrahedron, octahedron, dodecahedron, icosahedron, etc.), prisms, spheroids, ellipsoids, paraboloids, hyperboloids, rings, and combinations thereof. The three-dimensional solid excludes flat or planar solids, in which the L/D ratio is greater than 50:1. Such flat or planar solids include, for example, sheets, films, membranes, webs, and may be made of solid material (e.g., extruded from molten polymer) or fibrous material (e.g., porous sheet, film, or membrane, or a fibrous web (nonwoven)).

The solid 10 is comprised of a plurality of fibers. The fibers can be staple or filaments or a combination of both. The fibers can have a single length or the fibers lengths can vary. The fibers can have a single denier or the fibers can have varying deniers. The plurality of fibers can be made of a single polymer or a mixture of fibers made of differing polymers. Suitable polymers may be any fiber formable polymer, i.e., melt spinnable or solution spinnable. Such polymers can be, but are not limited to, polyolefins, polyesters, polyamides, and cellulosics. The plurality of fibers can include binder fibers, which can be bicomponent fibers. The ratio of binder fibers to total fibers is preferably in the range of 5-40:100. Bicomponent fibers can be, for example, sheath-core, side-by-side, or island-in-the-sea type bicomponent fibers, in which the first component of the fiber is a low polymer melt (in relation to the second polymer) and the second component is a high melt polymer (in relation to the first polymer).

According to an embodiment of the invention, the fibers can have different cross sectional shapes, such as round, cruciform, trilobal, pentalobal and flat. Varying the cross section of the fibers can change the flow characteristics allowing for more complete particle capture and/or segregate captured particles by one type of fiber, while other fibers stay clear keeping the pressure drop low.

At least some of the fibers are oleophilic, or oleophilic and hydrophobic. The oleophilic fibers can be naturally oleophilic, or chemically modified to be oleophilic, or include an oil-absorbing particle, or a combination thereof. The oil-absorbing particle can be on the surface of the fiber or embedded within the fiber, or a combination thereof. According to a preferred embodiment of the invention, the fiber can have an adhesive surface, and the oil-absorbing particle can be affixed to the adhesive surface. The adhesive surface can be a thermally active surface and/or a tacky surface.

According to an embodiment of the invention, the thermally active surface can be obtained by the use of a bicomponent fiber, in which the first component of the fiber is a low polymer melt in relation to the second polymer, and the second component is a high melt polymer in relation to the first polymer. Bicomponent fibers can be, for example, sheath-core, side-by-side, or island-in-the-sea type bicomponent fibers.

According to another embodiment of the invention, the tacky surface can be obtained by applying a plasticizer to the fiber or the surface of the fiber. For example, the plasticizers, triacetin or TEGDA (triethylene glycol diacetate), can be used to plasticize the surface of a cellulosic (e.g., cellulose acetate).

In yet another embodiment, the tacky surface can be obtained by applying a tackifier to the fiber or the surface of the fiber. The tackifier can be any adhesive with good tack properties.

In yet another embodiment of the invention, the tacky surface can be obtained by applying a chemical agent to the fiber or the surface of the fiber. For example, a polyamide (nylon) fiber can be treated with an acid solution.

The oil-absorbing particle can be any oil-absorbing particle. The oil-absorbing particles can be natural or synthetic materials. Commercially available oil-absorbing particles include, but are not limited to, the oil-absorbing product sold under the name “IMBIBER BEADS” by Imbiber Technologies of Welland, Ontario, Canada, and oil-absorbing products sold by OSM Environmental of Newark, N.Y. under the names “7X” and “ECONOZORB.”

The filter media can be comprised of fibers of different material, denier and/or cross sectional shape that are blended and carded together. According to a preferred embodiment of the invention, the filter media can be comprised of a polypropylene core and high-density polyethylene sheath bicomponent fiber blended with polyethylene terephthalate.

In a method of separating oil and aqueous material according to a preferred embodiment of the invention, oil/aqueous material is contacted with the above described filter media. Contact can be caused in a variety of ways, such as spreading the media on the oil/aqueous material (e.g., cleaning up a spill), or passing the oil/aqueous material through a filter device. The filter device can include a cartridge having an inlet and an outlet, and the cartridge is filled with the filter media, described above.

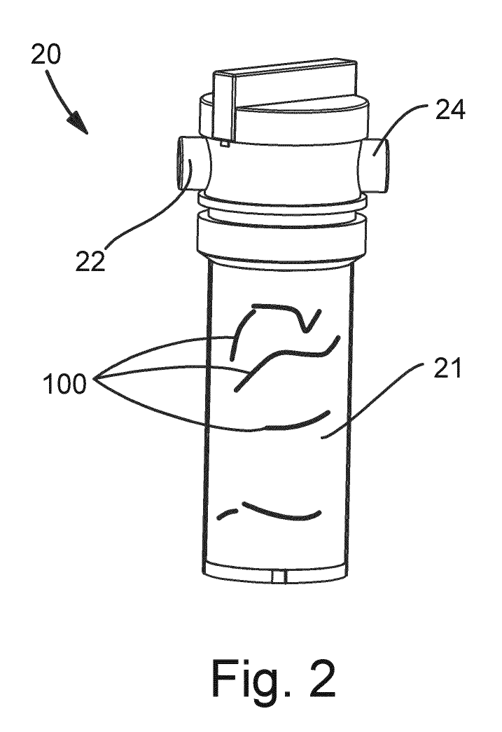

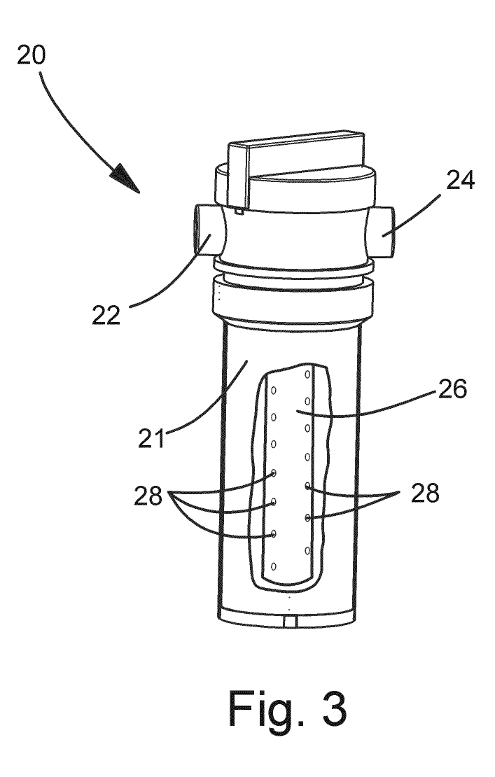

According to another preferred embodiment of the invention, the above described filter media can be used in a filter apparatus, such as the filter cartridge illustrated in FIGS. 2 and 3, and shown generally at reference numeral 20. As shown in FIG. 2, the filter cartridge 20 comprises an elongate housing 21 that contains filter media 100, which can be comprised of the solids 10, shown in FIG. 1. The filter cartridge 20 includes an inlet 22 and an outlet 24. The filter cartridge 20 includes an exit pipe 26 having openings formed therein, as shown in FIG. 3. (FIG. 3 shows the filter cartridge 20 with the filter media 100 removed to clearly show the exit pipe 26.) Filter media 100 surrounds the exit pipe 26, and the exit pipe 26 is in communication with the outlet 24. A fluid containing filterable matter is received through the inlet 22 of the filter cartridge 20. The filterable matter is separated from the fluid by the filter media 100. The filtered fluid is received through the openings 28 of the exit pipe 26, and is extracted from the outlet 24 of the cartridge 20.

An oil/water separation medium and method of using same are described above. Various changes can be made to the invention without departing from its scope. The above description of various embodiments and best mode of the invention are provided for the purpose of illustration only and not limitation—the invention being defined by the claims and equivalents thereof.

What is claimed is:

1. A filter medium for removing oil from an aqueous material comprising a three dimensional solid comprised of a plurality of fibers, wherein at least some of the fibers are oleophilic fibers.

2. The filter medium according to claim 1, wherein at least some of the fibers are oleophilic and hydrophilic.

3. The filter medium according to claim 1, wherein the plurality of fibers comprise at least one polymer selected from the group consisting of polyolefin, polyester, polyamide, and cellulosic.

4. The filter medium according to claim 1, wherein the plurality of fibers comprise at least two different polymers.

5. The filter medium according to claim 4, wherein the plurality of fibers comprise at least two polymers selected from the group consisting of polyolefin, polyester, polyamide, and cellulosic.

6. The filter medium according to claim 1, wherein the plurality of fibers comprise a first fiber having a first denier, and a second fiber having a second denier different from the first denier.

7. The filter medium according to claim 1, wherein the three dimensional solid has a shape selected from the group consisting of sphere, cylinder, cone, cube, cuboid, parallelepiped, polyhedron, prism, spheroid, ellipsoid, paraboloid, hyperboloid, and ring.

8. The filter medium according to claim 1, wherein the oleophilic fibers have an adhesive surface and an oil-absorbing particle affixed to the adhesive surface.

9. The filter medium according to claim 8, wherein at least some of the fibers are oleophilic and hydrophilic, and have an adhesive surface and an oil-absorbing particle affixed to the adhesive surface.

10. The filter medium according to claim 8, wherein the adhesive surface comprises a thermally active surface.

11. The filter medium according to claim 8, wherein the adhesive surface comprises a tacky surface.

12. The filter medium according to claim 11, wherein the tacky surface includes a tackifier.

13. The filter medium according to claim 11, wherein the tacky surface includes a plasticizer.

14. The filter medium according to claim 11, wherein the tacky surface is tackified by a chemical agent.

15. A filter apparatus comprising a cartridge having an inlet and an outlet, and containing filter media adapted for removing oil from an aqueous material, the filter media comprising a three dimensional solid comprised of a plurality of fibers, wherein at least some of the fibers are oleophilic fibers.

16. The filter apparatus according to claim 15, wherein at least some of the fibers are oleophilic and hydrophilic.

17. The filter apparatus according to claim 15, wherein the plurality of fibers comprise at least two polymers selected from the group consisting of polyolefin, polyester, polyamide, and cellulosic.

18. The filter apparatus according to claim 15, wherein the plurality of fibers comprise a first fiber having a first denier, and a second fiber having a second denier different from the first denier.

19. The filter apparatus according to claim 15, wherein each of the oleophilic fibers have an adhesive surface and an oil-absorbing particle affixed to the adhesive surface.

20. The filter media according to claim 19, wherein the adhesive surface is thermally active surface or tacky.
